(19) United States
(12) Patent Application Publication
(10) Pub. No.: US 2006/0059374 A1
(43) Pub. Date: Mar. 16, 2006

(54) Method for securing computer systems by software containment

(75) Inventors: Patrice Hameau, Boulogne Billancourt (FR); Daniel Le Metayer, Le Chesnay (FR); Cedric Mesnil, Les Clayes Sous Bois (FR)

Correspondence Address: BROWDY AND NEIMARK, P.L.L.C.;624 NINTH STREET, NW, SUITE 300, WASHINGTON, DC, 20001-5303, US

(73) Assignee: Trusted Logic, Versailles (FR)

(21) Appl. No.: 10/540,325

(22) PCT Filed: Dec. 23, 2003
(86) PCT No.: PCT/FR03/03904

§ 371 Date: Jun. 22, 2005

(30) Foreign Application Priority Data
Dec. 24, 2002 (FR) 02/16933

(51) Int. Cl. H04L 9/32

(52) U.S. Cl. 713/193; 711/170

(57) ABSTRACT

The invention relates to a method of securing computer systems involving the logical containment of data. More specifically, the invention relates to a method of securing computer systems, which offers the possibility of executing codes that manipulate data which must be processed separately. The inventive method essentially involves the use of the following: (i) a memory manager for managing memory allocation units which can be typically a fixed-size page or a variable-size block, and (ii) memory allocation owners and requesters which can be typically user applications of the operating system of the computer system or the actual operating system. The system involves the separation of the aforementioned data by the owner and the encryption of same with a dedicated key.

The present invention relates to securing computer systems by logical confinement of data.

More specifically, it is directed to securing computer systems, providing the possibility of executing codes which manipulate data which must be processed separately. This separation is generally dictated by needs for security. As an example, the data of the operating system which condition proper operation of the platform must not be able to be changed by any application. Also, in systems allowing execution of multiple applications, the data of one application should generally be protected from other applications.

In certain cases, these needs assume a critical character; for example, one may imagine in a non-limiting way, multi-application embedded systems of the chip card type, payment terminals, digital assistants, or portable telephones, especially when the embedded systems allow remote downloading of applications. Indeed, these downloaded applications may be issued from multiple sites, which offer highly varied guarantees of reliability.

Generally, it is known that most of the generally adopted solutions for meeting this need for separating said operating system data and application data rely on the use of mechanisms provided by the hardware. Typically, (physical) units for managing memory (memory management units (MMU)) associate physical spaces with applications and protect them against accesses from other applications. However, this solution, when it is available, is not very flexible and it is difficult to associate it with systems for dynamic allocation of data, (the number of physical spaces being fixed), especially in the case of embedded systems having little resources and subjected to strong security constraints.

So the object of the present invention more specifically is to find a remedy to these drawbacks.

For this purpose, it proposes to make the securing of data more flexible and to extend it to the case of dynamic allocation of memory.

Essentially it involves:
at least one memory manager managing memory allocation units which may typically be a page with a fixed size or a block with a variable size,
at least possessors and requesters of memory allocation which may typically be applications of the user of the operating system of the computer system or the operating system itself.

According to the invention, the method for securing a computer system by logical confinement of data comprises separation of said data per possessor and their encryption with a dedicated key; this separation and encryption process is performed by a procedure comprising the following steps:
an allocation of memory performed by a memory manager on request from another component of the operating system which transmits to said memory manager, the identity of the requester. This requester will become the possessor of the allocated memory. Transmission of the identity of the requester may be accomplished either by managing a current context, or by passing parameters to the functions of the memory manager;
a check by the aforesaid memory manager of the whole of the memory allocation units, each being associated with a possessor of the memory allocation unit. Each memory allocation unit can only have one single possessor; nevertheless, several memory allocation units may have the same possessor;
an encryption of the data of each possessor by means of a key associated with this possessor;
optionally, a use of a secret associated with each possessor, by the memory manager. This secret may typically be provided to the memory manager by the operating system at the moment when the possessor is introduced into the system and upon each access to a memory allocation unit;
optionally, a use of a key for each possessor by the memory manager. This key may for example be derived from a secret associated with the possessor and a so-called “master” key to which only the memory manager has access;
a check of the identity of the requester by the memory manager for each request to access a memory allocation unit; if this identity is not identical with that of the possessor of said memory allocation unit, then the access to the memory allocation unit is refused by the memory manager;
performing, by means of the memory manager, encryption (in the case of a write request) or decryption (in the case of a read request) of the relevant data with the key associated with the possessor, whereby this key may be re-calculated by the memory manager.

Hence, as the data of the different possessors are automatically encrypted with a secret, only known to the memory manager, it is impossible for an application to have access to the data of another possessor.

Two situations may occur when a third party attempts to access a memory allocation unit which does not belong to him:
this attempt may be triggered via the memory manager: in this case, the check performed by the memory manager automatically leads to rejection of the request;
this attempt may be triggered illegally, without passing through the memory manager, by directly accessing the physical memory, if the checks performed by the hardware are not sufficient for ruling out this possibility: the third party may then perform a read, but, as it does not have the decryption key, unusable data will be obtain.

As soon as the master key is stored in a protected area, confidentiality of the data is therefore preserved in both cases.

Advantageously, the method according to the invention does not depend on the fact that the memory allocation unit is a logical page with a fixed size or a block with a variable size. If the allocation unit is the page, the method will be refined in the following way: when the memory manager receives a request for allocating a block on behalf of a possessor, it first searches for a page with the same possessor; so, all the blocks allocated by a possessor of a memory allocation unit are found grouped in one or more dedicated pages.

The method according to the invention may be improved in several (non exclusive) ways:
Instead of associating a unique key with a given possessor, the memory manager may associate a key with each set of possessor and memory allocation unit. This improvement has two advantages: it reduces the probabilities for discovering the keys used on the one hand (in the case of a cryptographic attack) as each key will be used less frequently; on the other hand, it reduces the risks in the case of discovery of a key as only the associated memory allocation unit will be endangered.
The memory manager may also integrate into each memory unit, an area allowing its integrity to be checked, for example from a simple signed checksum or a cryptographic algorithm. The datum contained in this area is updated by the memory manager upon each write access to the unit. It may be used by the memory manager for checking purposes, either systematically at each access to the unit, or periodically. The check before the requested access simply consists of recalculating the integrity datum from the contents of the unit (plain data) and comparing it with the datum contained in the integrity area. An untimely or illegal change in the contents of the unit may then be detected, which will reinforce security of the data management.
By associating different security levels with applications and by using different encryption means (algorithms, lengths of keys, typically) according to the associated security level, it is possible to proportion the implementation cost (notably the execution times) to the sought-after goal, as regards security.

As a non-limiting example, reserving the most powerful (and most costly) cryptographic means for protecting a memory unit intended to receive the encryption keys or access rights may be justified.
Combination of the method according to the invention with a physical protection mechanism (MMU) provides protection with finer granularity. For example, applications may be grouped together into several large categories (optionally, and in a non-limiting way, according to the confidence level which may be assigned to them, the first natural distinction may be between the users' applications and the operating system's applications), each category being protected from the others by the physical mechanism and applications being protected from each other by the software confinement method according to the invention.

1. A method for securing by software confinement, a computer system which executes codes which manipulate data, involving:
at least one memory manager managing memory allocation units which may typically be a page with a fixed size or a block with a variable size, and
at least possessors and requesters of memory allocation units which may typically be an application of the user of the operating system of the computer system or the operating system itself,
said method comprising the following steps:
an allocation of memory performed by the memory manager upon request from another component of the operating system which transmits to said memory manager, the identity of the requester;
a check by the aforesaid memory manager of the whole of the allocation units, each being associated with a possessor of the memory allocation unit;
an encryption of the data of each possessor by means of a key associated with this possessor;
a check by the memory manager, for each request to access a memory allocation unit, of the identity of the requester; if this identity is not identical to that of the possessor of said memory allocation unit, then access to the memory allocation unit is refused by the memory manager; and
performance, by means of the memory manager, of encryption (in the case of a write request) or decryption (in the case of a read request) of the relevant data with the key associated with the possessor, this key being at least recalculated by the memory manager.

2. The method according to claim 1, wherein the allocation unit is the page, and the memory manager, when it receives a request for allocating a block on behalf of a possessor of a memory allocation unit, first searches for a page with the same possessor so that all the blocks allocated by said possessor are found grouped in one or several dedicated pages.

3. The method according to claim 1, wherein transmission of the identity of the requester is accomplished either by managing a current context, or by passing parameters to the functions of the memory manager.

4. The method according to claim 1, wherein the memory manager dynamically calculates the key of a possessor from a secret associated with said possessor and a so-called master key to which only the memory manager has access.

5. The method according to claim 1, wherein the memory manager associates the key with each set of possessor and memory allocation unit instead of associating a unique key with each possessor.

6. The method according to claim 1, wherein the memory manager integrates into each memory allocation unit, an area with which the integrity of the latter may be checked.

7. The method according to claim 1, further including associating different security levels with the applications and using different encryption means according to the associated security level.

8. The method according to claim 1, being combined with a physical protection mechanism.

9. The method according to claim 1, being implemented on an embedded system such as a terminal of the portable telephone type, a bank payment terminal, a portable payment terminal, a digital assistant or PDA, a chip card.
